(19) United States
(12) Patent Application Publication
(10) Pub. No.: US 2008/0078846 A1
(43) Pub. Date: Apr. 3, 2008

(54) Liquid condiment dispenser

(76) Inventor: Jui-Cheng Tsai, An Nan District (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/520,602

(22) Filed: Sep. 14, 2006

(51) Int. Cl. A62C 11/00

(52) U.S. Cl. 239/333; 239/487; 239/489

(57) ABSTRACT

A liquid condiment dispenser includes a container with a separation board to define an upper space and a lower space. An outlet is defined through a hollow body defining the lower space. A rod cooperated with a button extends through the separation board and has a first seal ring to removably seal the hole of the separation board. A second seal ring is securely engaged with an inner periphery of the second space so that when the rod is pushed, the first seal ring allows the liquid condiment in the upper space to flow to the lower space and liquid condiment is pushed from the outlet in the distal end of the hollow body. The rod is pushed upward by a spring to seal the hole again when releasing the button.

### FIELD OF THE INVENTION

The present invention relates to a liquid condiment dispenser which includes a button for dispensing the liquid condiment from the bottom of the dispenser.

### BACKGROUND OF THE INVENTION

A conventional liquid condiment jar 1 is shown in FIG. 1 and generally includes a container 11 with a cap 12 which has a tubular spout 121 through which the liquid condiment flows. However, the liquid condiment tends to flow along the tubular spout 121 and down to the container 11 such that the next user might be in contact with the condiment on the container 11. Besides, the condiment usually dries and blocks the opening of the spout 121 and the dried condiment generates bad smell. Furthermore, the cap 12 might not be securely mounted to the container 11 after each refill so that the next user could separate the cap 12 and the container 11 and splash the liquid condiment on his or her clothes.

The present invention intends to provide a liquid condiment dispenser which is used by pressing a button to dispense a pre-set amount of the liquid condiment.

### SUMMARY OF THE INVENTION

The present invention relates to a liquid condiment dispenser that comprises a container having a separation board to defined an upper space and a lower space in the container, a hole is defined through the separation board and a rod extends through the hole. The lower space is defined by a hollow body with at least one outlet defined through a distal end of the hollow body. A cap is connection to an open top of the container and a movable member movably extends through the cap and is connected with a first end of the rod. A second end of the rod movably extends through the hole and a first seal ring is mounted to the rod so as to removably seal the hole. An annular groove is defined in an outer periphery of the rod so as to form a neck and a plurality of paths are defined in an outer surface of neck and an upward annular surface surrounding the neck. A second seal ring is located beneath the first seal ring and securely engaged with an inner periphery of the hollow body.

A spring is biased between the second end of the rod and an inner end of the hollow body so as to push the rod upward to let the first seal ring seal the hole and to let the second seal ring be located on the upward annular surface surrounding the neck. The paths are in communication between two rooms separated by the second seal ring in the hollow body. The rod is lowered by pressing the movable member and the first seal ring is removed from the hole and the second seal ring is in contact with a downward annular surface enclosing the neck to seal communication between the two rooms separated by the second seal ring.

The primary object of the present invention is to provide a liquid condiment dispenser which can dispense a pre-set amount of the liquid condiment by push a button.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of a conventional liquid condiment dispenser;

FIG. 2 is an exploded view to show the liquid condiment dispenser of the present invention;

FIG. 3 shows a section of the rod, the spring, the insertion member and the end member of the liquid condiment dispenser of the present invention;

FIG. 4 shows a cross sectional view of the liquid condiment dispenser of the present invention;

FIG. 5 shows a pre-set amount of liquid condiment is located in the lower space of the liquid condiment dispenser of the present invention;

FIG. 6 is a cross sectional view along line A-A in FIG. 5;

FIG. 7 is a cross sectional view along line B-B in FIG. 5;

FIG. 8 shows the rod is lowered to let the liquid condiment flow into the lower space;

FIG. 9 shows that when the rod is pushed upward by the spring, the liquid condiment flows to the end member via the paths, and

FIG. 10 shows another embodiment of the insertion member.

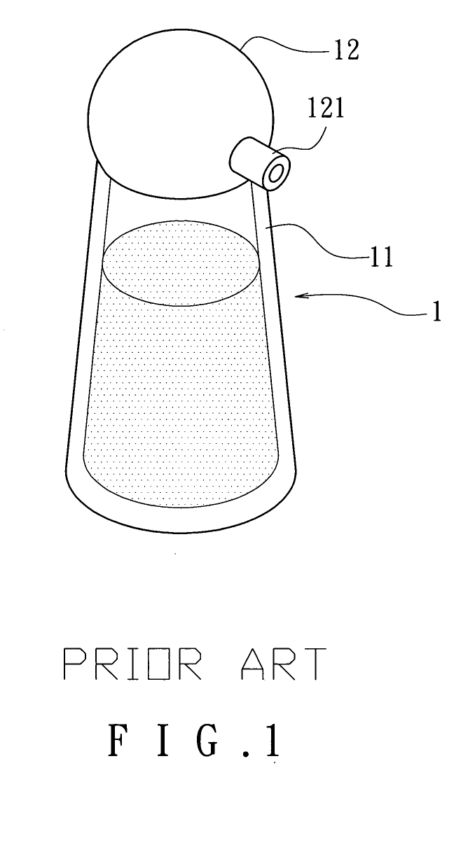

### DETAILED DESCRIPTION OF THE PREFERRED EMBODIMENT

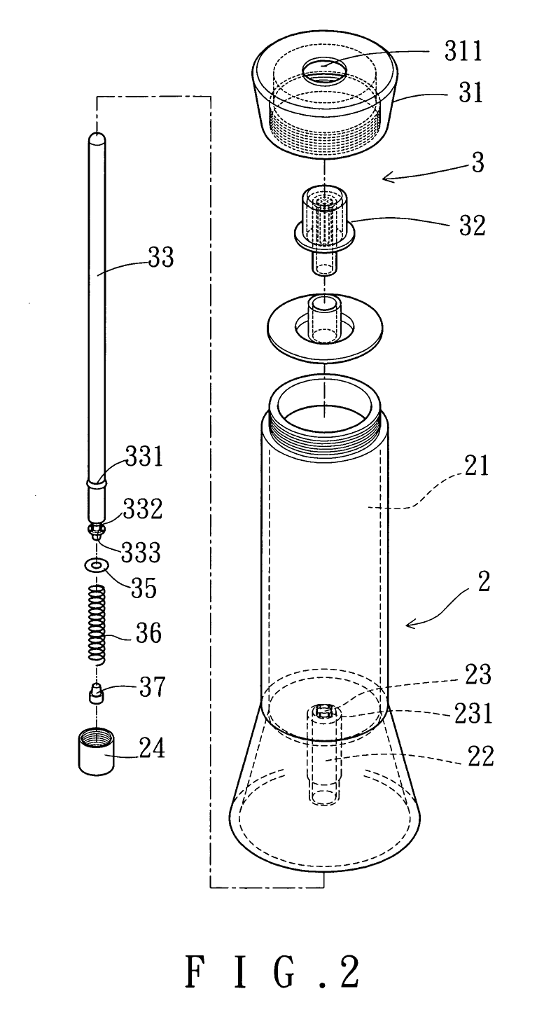

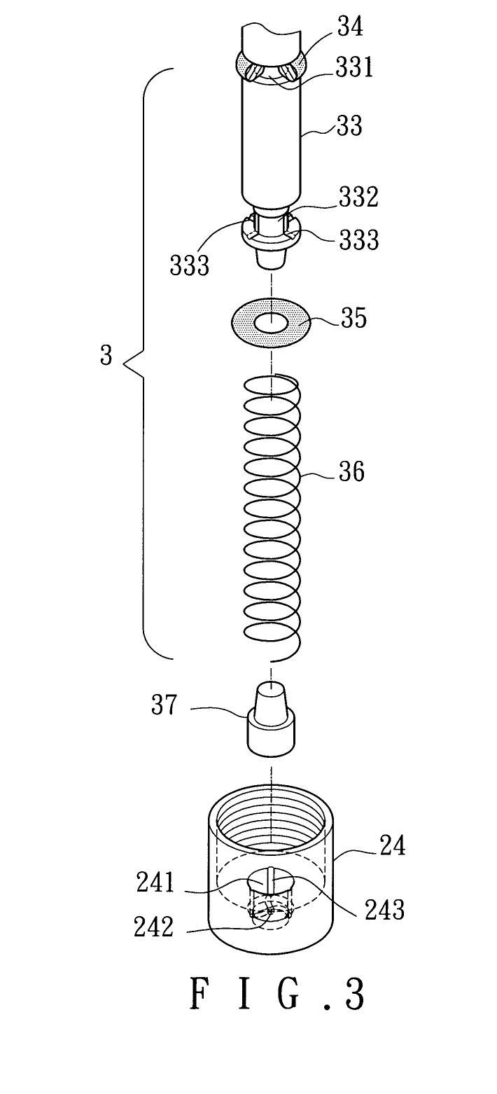

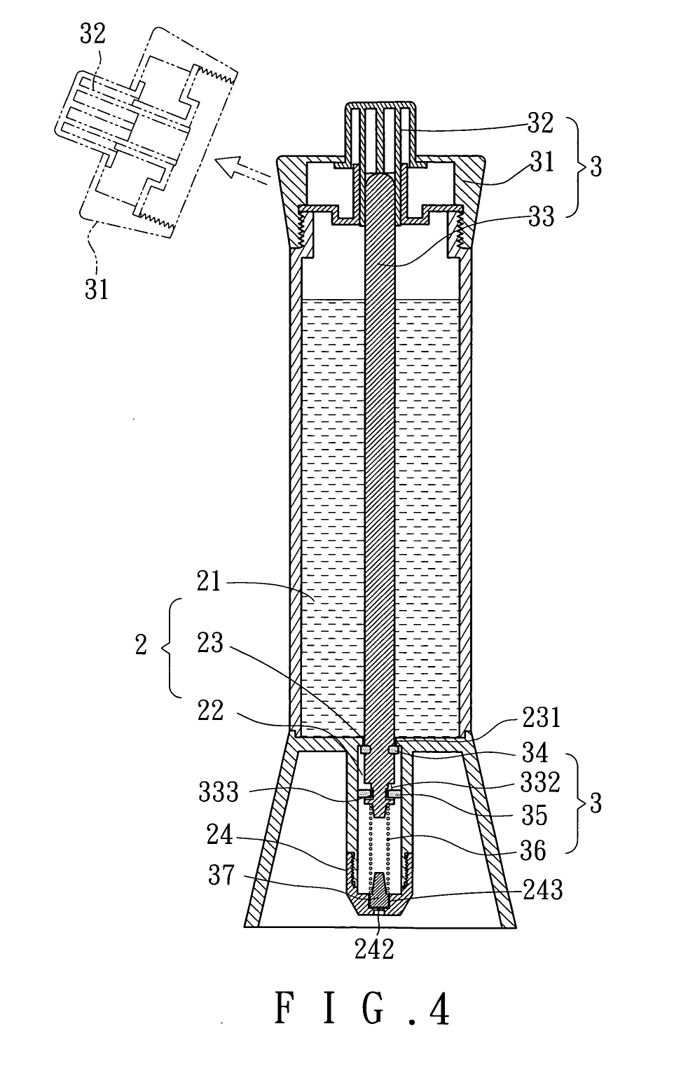

Referring to FIGS. 2 to 5, the liquid condiment dispenser of the present invention comprises a container 2 having a open top and a separation board is located therein so as to defined an upper space 21 and a lower space 22. A hole 23 is defined through the separation board and located in communication between the upper and lower spaces 21, 22. The lower space 22 is defined by a tubular hollow body with at least one outlet defined through a distal end of the hollow body.

A press unit 3 is connected to a top of the container 2 and includes a cap 31 and a movable member 32. The cap 31 is threadedly connection to the open top of the container 2 and the movable member 32 is movably extends through the cap 31 to form a button on a top of the cap 31.

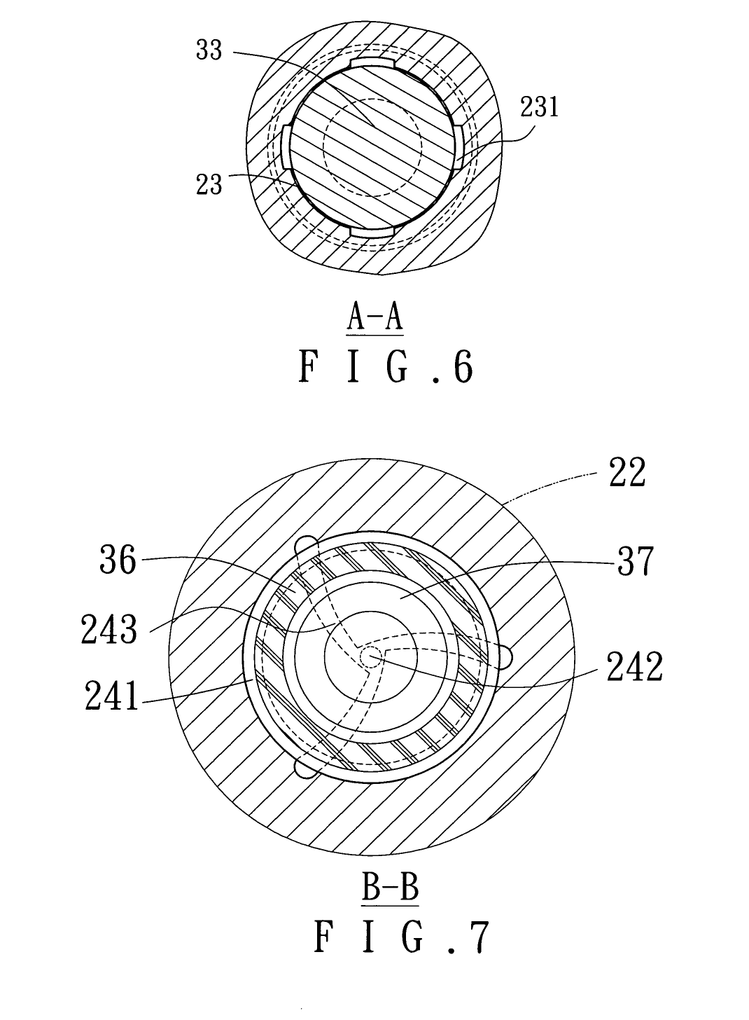

An end member 24 is connected to the distal end of the hollow body and includes a recess 241 defined in an inner end of the end member 24. Three plurality of spiral grooves 243 as shown in FIG. 7 are defined in an inner periphery of the recess 241 and an outlet 242 is in communication with the spiral grooves 243. An insertion member 37 is inserted in the recess 241 and in contact with the inner periphery of the recess 241 so as to define sizes of the spiral grooves 243.

A rod 33 is located in the container 2 and has a first end connected with the movable member 32 and a second end of the rod 33 movably extends through the hole 23. Longitudinal grooves 231 as shown in FIG. 6 are defined in an inner periphery of the hole 23. The rod 33 has an engaging groove 331 and a first seal ring 34 is engaged with the engaging groove 331 of the rod 33. The first seal ring 34 is located beneath the hole 23 so as to removably seal the hole 23. An annular groove 332 is defined in an outer periphery of the rod 33 so as to form a neck and a plurality of paths 333 are defined in an outer surface of neck and an upward annular surface surrounding the neck. A second seal ring 35 is located beneath the first seal ring 34 and securely engaged with an inner periphery of the hollow body. It is noted that the height of the annular groove 332 being larger than a thickness of the second seal ring 35 so that when the rod 33 is moved, the second seal ring 35 is not moved with the rod 33.

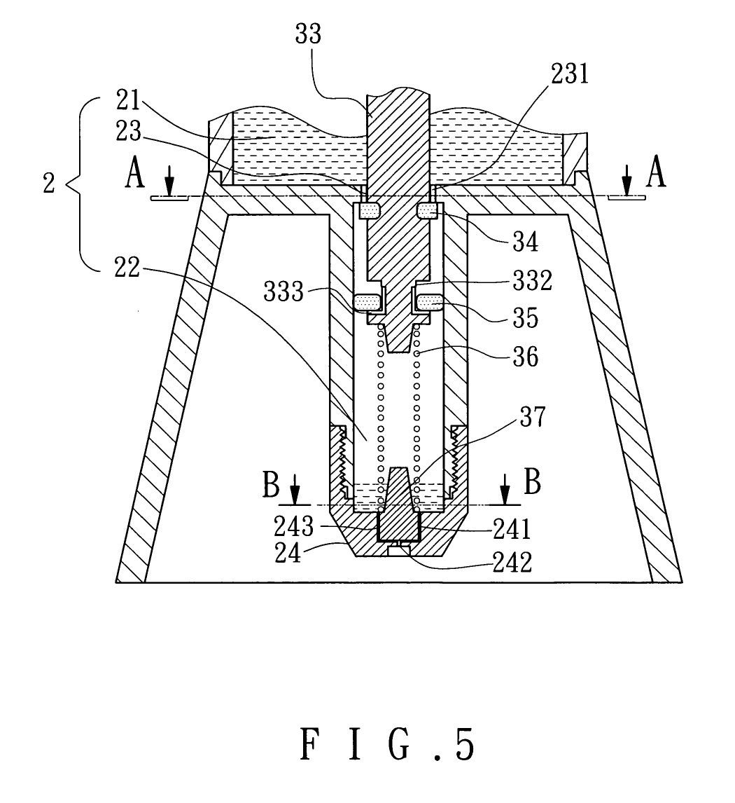

A spring 36 is biased between the second end of the rod 33 and the insertion member 27 so as to push the rod 33 upward to let the first seal ring 34 seal the hole 23 and to let the second seal ring 35 be located on the upward annular surface surrounding the neck as shown in FIG. 5. The paths 333 are in communication between two rooms separated by the second seal ring 35 in the hollow body.

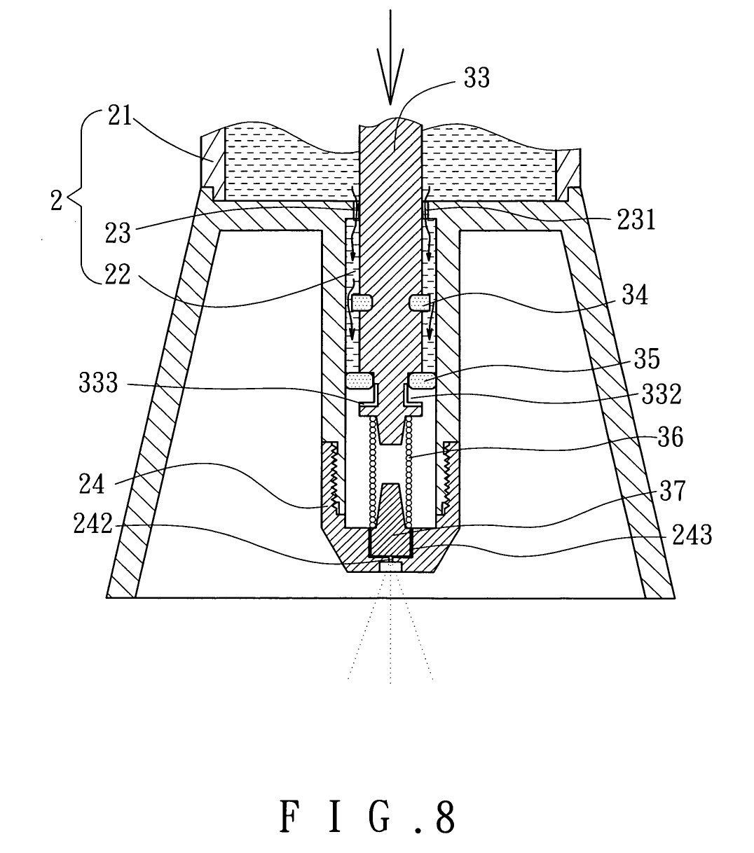

As shown in FIG. 8, When press the movable member 32 and hold the movable member 32, the rod 33 is lowered and the first seal ring 34 is removed from the hole 23, and the second seal ring 35 is in contact with a downward annular surface enclosing the neck 332 to seal communication between the two rooms separated by the second seal ring 35. The liquid condiment flows into the upper one of the two rooms in the lower space via the hole 23 and the Longitudinal grooves 231. Because the second seal ring 35 is in contact with the downward annular surface surrounding the neck so that the liquid condiment cannot enter into the lower one of the two rooms in the lower space.

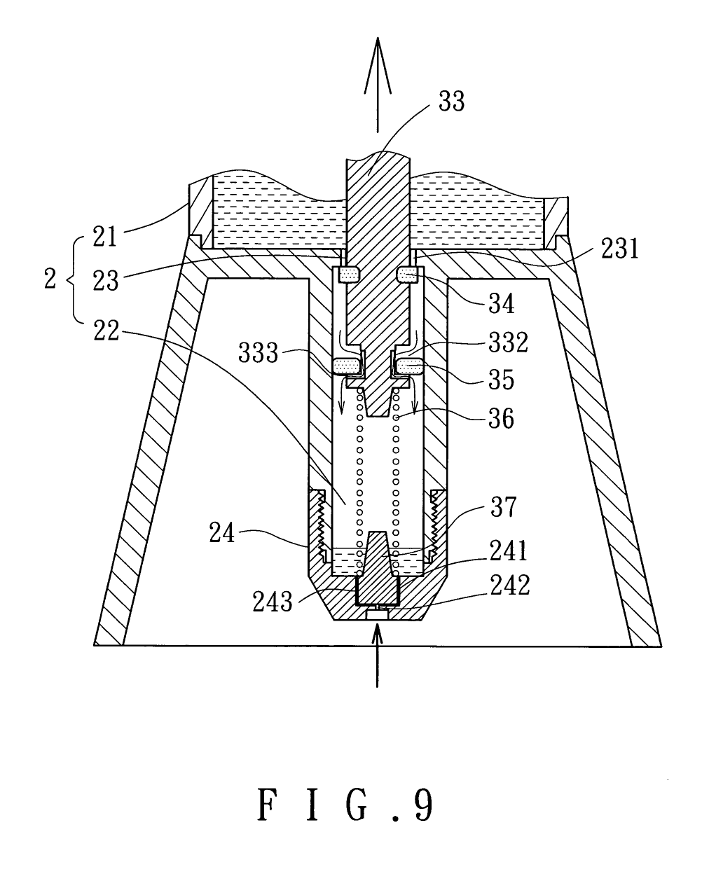

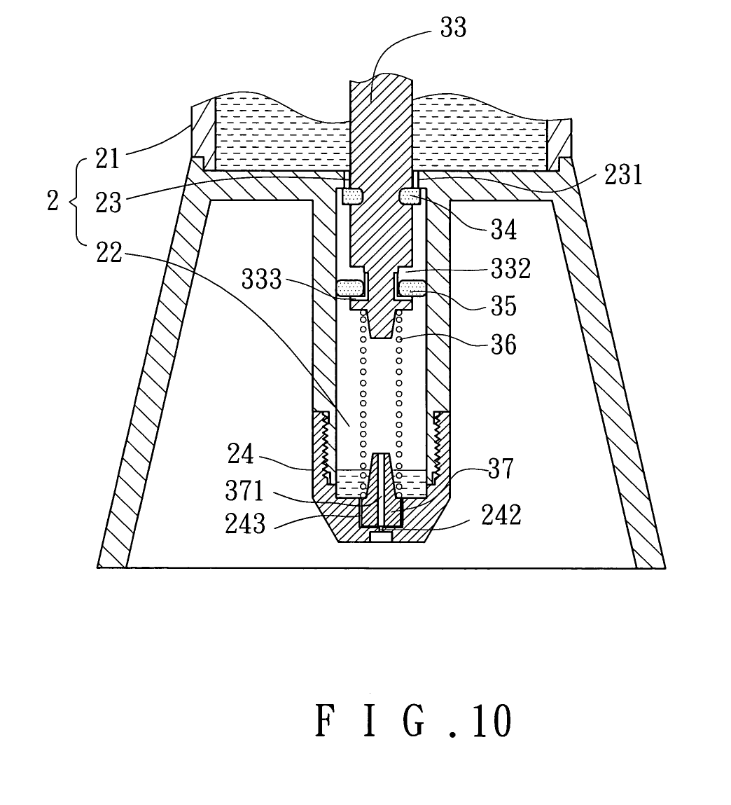

When releasing the movable member 32 as shown in FIG. 9, the rod 33 is pushed upward by the spring 36 and the liquid condiment flows into upper one of the two rooms to the lower one of the two rooms via the paths 333. Because the upward movement of the rod 33 suck the air in the lower one of the two rooms so that the lower one of the two rooms has low pressure and the liquid condiment cannot flow through the spiral grooves 243. When the user pushes the movable member 32 again, the downward movement of the rod 33 pushes the liquid in the liquid condiment through the outlet 242. The amount of the liquid condiment is fixed in the upper one of the two rooms so that each time the user pushes the movable member 32, a pre-set amount of the liquid condiment is dispensed. The distance between the first and second seal rings 34, 35 decides the amount of each dispense, so that the amount of the liquid condiment can be pre-set and adjustable.

The user's hands do not contact the liquid condiment during using the dispenser of the present invention and there will be no dried condiment at the outlet 242 because the liquid condiment is pushed by air pressure.

As shown in FIG. 10, if the liquid condiment has larger molecular such as oil based condiment, an air passage 371 is defined longitudinally through the insertion member 27 to introduce air into the lower space to assist the upward movement of the rod 33 when the user releasing the movable member 32.

While we have shown and described the embodiment in accordance with the present invention, it should be clear to those skilled in the art that further embodiments may be made without departing from the scope of the present invention.

What is claimed is:

1. A liquid condiment dispenser comprising:
a container having a separation board located therein so as to defined an upper space and a lower space, a hole defined through the separation board and located in communication between the upper and lower spaces, the lower space defined by a hollow body with at least one outlet defined through a distal end of the hollow body;
a press unit connected to a top of the container and including a cap and a movable member, the cap connection to an open top of the container and the movable member movably extends through the cap, and
a rod located in the container and having a first end connected with the movable member and a second end of the rod movably extending through the hole, a first seal ring mounted to the rod and located beneath the hole so as to removably seal the hole, an annular groove defined in an outer periphery of the rod so as to form a neck and a plurality of paths defined in an outer surface of neck and an upward annular surface surrounding the neck, a second seal ring located beneath the first seal ring and being securely engaged with an inner periphery of the hollow body, the height of the annular groove being larger than a thickness of the second seal ring, a spring biased between the second end of the rod and an inner end of the hollow body so as to push the rod upward to let the first seal ring seal the hole and to let the second seal ring be located on the upward annular surface surrounding the neck, the paths being in communication between two rooms separated by the second seal ring in the hollow body, the rod being lowered by pressing the movable member and the first seal ring being removed from the hole and the second seal ring being in contact with a downward annular surface enclosing the neck to seal communication between the two rooms separated by the second seal ring.

2. The dispenser as claimed in claim 1, wherein an end member is connected to the distal end of the hollow body and includes a recess defined in an inner end of the end member, a plurality of spiral grooves are defined in an inner periphery of the recess and the at least one outlet is in communication with the spiral grooves, an insertion member is inserted in the recess and in contact with the inner periphery of the recess so as to define sizes of the spiral grooves.

3. The dispenser as claimed in claim 1, wherein longitudinal grooves are defined in an inner periphery of the hole.

4. The dispenser as claimed in claim 2, wherein the insertion member includes an air passage defined longitudinally therethrough.
